(19) United States
(12) Patent Application Publication
(10) Pub. No.: US 2014/0108960 A1
(43) Pub. Date: Apr. 17, 2014

(54) Creating Threaded Multimedia Conversations

(71) Applicant: MICROSOFT CORPORATION, Redmond, WA (US)

(72) Inventors: Richard Ignacio Zaragoza, Sammamish, WA (US); Rejeev V. Karunakaran, Redmond, WA (US); Steven Wayne Ickman, Snoqualmie, WA (US); Paul A. Steckler, Redmond, WA (US); William Lawrence Portnoy, Woodinville, WA (US)

(73) Assignee: MICROSOFT CORPORATION, Redmond, WA (US)

(21) Appl. No.: 13/653,406

(22) Filed: Oct. 17, 2012

(51) Int. Cl. G06F 3/01

(52) U.S. Cl. 715/753

(57) ABSTRACT

Various embodiments provide an ability for users to locate relevant multimedia building blocks for use in adding to posts in a manner which robustly adds to a particular conversation. A thread of conversation can be created across many posts and times. The notion of textual of replies is extended by allowing a multimedia conversation across a series of posts. Multimedia conversation lineages can be tracked and visualized across a series of posts, thus allowing for a non-linear tree of connections among related posts. In addition, an integrated social search engine can be utilized to provide for a shared context for constructing derivative posts.

### BACKGROUND

Social network sites are currently very popular. Many social network sites basically attempt to capture a social graph of connections among users. The users are often family members, classmates, and other prior acquaintances.

Within a particular social networking site, a small number of users may choose to “like” another user's content and, an even smaller number of users may choose to create new content. Creating new content, starting from a blank canvas, can be challenging for many users. In addition, when many users post to a single feed or posting, the posted content can be very transitory and there may be little opportunity to comment on individual posts.

Further, replying to a single post using a textual response merely provides a simple annotation on the original content. This, in turn, limits the “conversation” to simple responses that pertain to just the single post.

### SUMMARY

This Summary is provided to introduce a selection of concepts in a simplified form that are further described below in the Detailed Description. This Summary is not intended to identify key features or essential features of the claimed subject matter.

Various embodiments provide an ability for users to locate relevant multimedia building blocks for use in adding to posts in a manner which robustly adds to a particular conversation.

In one or more embodiments, a thread of conversation can be created across many posts and times. Embodiments can extend the notion of textual replies by allowing a multimedia conversation across a series of posts. Multimedia conversation lineages can be tracked and visualized across a series of posts, thus allowing for a non-linear tree of connections among related posts. Various embodiments can allow for a community-driven collaborative effort such as, for example, collaborative stories, word associations, and the like, instead of fixed-structure, purpose-built interactions.

In addition, at least some embodiments can utilize an integrated social search engine to provide for a shared context for constructing derivative posts.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation in accordance with one or more embodiments.

FIG. 2 is an illustration of a system in an example implementation showing FIG. 1 in greater detail.

FIG. 3 illustrates an example user interface in accordance with one or more embodiments.

FIG. 4 illustrates an example user interface in accordance with one or more embodiments.

FIG. 5 illustrates an example user interface in accordance with one or more embodiments.

FIG. 6 illustrates an example system in accordance with one or more embodiments.

FIG. 7 is a flow diagram that describes steps in a method in accordance with one or more embodiments.

FIG. 8 illustrates an example computing device that can be utilized to implement various embodiments described herein.

### DETAILED DESCRIPTION

Overview

Various embodiments provide an ability for users to locate relevant multimedia building blocks for use in adding to posts in a manner which robustly adds to a particular conversation. In the context of this document, this ability is referred to as “riffing”.

In one or more embodiments, a thread of conversation can be created across many posts and times. Embodiments can extend the notion of textual replies by allowing a multimedia conversation across a series of posts. Multimedia conversation lineages can be tracked and visualized across a series of posts, thus allowing for a non-linear tree of connections among related posts. Various embodiments can allow for a community-driven collaborative effort such as, for example, collaborative stories, word associations, and the like, instead of fixed-structure, purpose-built interactions.

In addition, at least some embodiments can utilize an integrated social search engine to provide for a shared context for constructing derivative posts.

As will become apparent below, riffing is a method to create threaded multimedia conversations. In various embodiments, riffing allows users to create derivative posts that are linked to other posts in a threaded format. Each post can stand alone and has the full complement of text/links/images/videos, but the parent post provides a richer thread of conversation. Riffing provides the opportunity to incrementally contribute to a conversation rather than having to start with a blank canvas. As such, a rich multimedia conversation can emerge across several posts. The process of linking posts allows the conversation topic to be more flexible, allowing for tangents and the ability to extend and interweave topics.

Riffing thus creates a semantic structure across many posts, allowing for a richer browse experience to go beyond standard author or term-based search queries. This structure can be visualized explicitly in a tree form in the user interface, or as part of viewing the ancestor source posts for any particular post surfaced during a normal search in a social search engine.

While many riffs can be created after their source post, it is possible to explicitly link an earlier isolated post into a riff chain to further enrich the thread of the idea or conversation.

In the following discussion, an example environment is first described that is operable to employ the techniques described herein. Example illustrations of the various embodiments are then described, which may be employed in the example environment, as well as in other environments. Accordingly, the example environment is not limited to performing the described embodiments and the described embodiments are not limited to implementation in the example environment.

Example Operating Environment

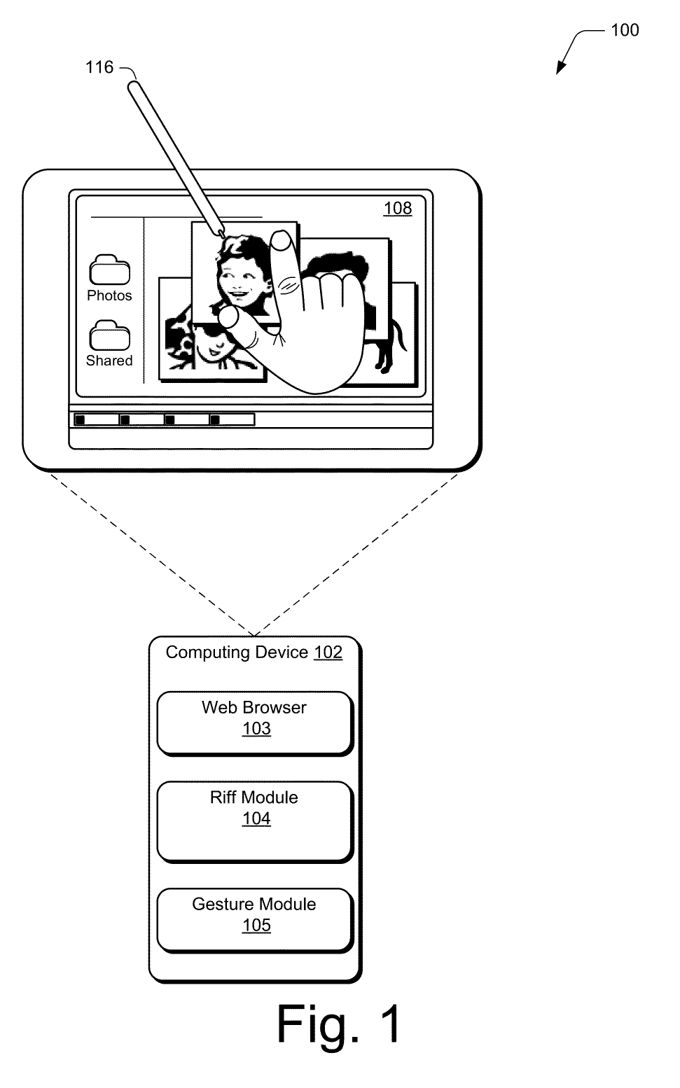

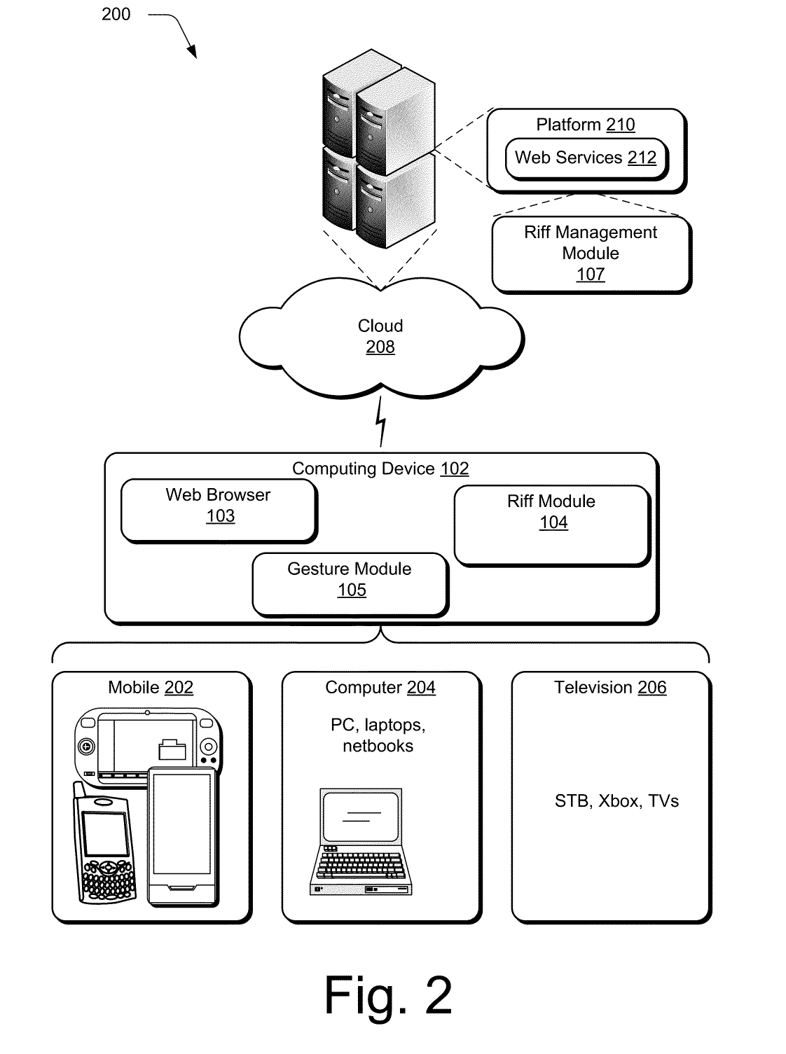

FIG. 1 is an illustration of an environment 100 in an example implementation that is operable to employ the techniques described in this document. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device, and so forth as further described in relation to FIG. 2. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 also includes software that causes the computing device 102 to perform one or more operations as described below.

Computing device 102 includes a web browser 103 and a riff module 104 configured to enable threaded multimedia conversations to be created, as described below. Although riff module 104 is shown as representing a separate component from web browser 103, it can be implemented as a part of the web browser. The computing device 102 also includes a gesture module 105 that is configured to recognize various gestures, at least some of which are described herein.

Web browser 103 is representative of functionality that enables the user to browse navigable content on the network, such as the Internet. Using the web browser, a user can navigate to a social networking site and participate in the riffing process as described in more detail below.

Riff module 104 is representative of functionality that can, in at least some embodiments, work in concert with web browser 103 to enable threaded, multimedia conversations to be created as described above and below.

Computing device 102 also includes a gesture module 105 that recognizes gestures that can be performed by one or more fingers, and causes operations to be performed that correspond to the gestures. The gestures may be recognized by module 105 in a variety of different ways. For example, the gesture module 105 may be configured to recognize a touch input, such as a finger of a user's hand as proximal to display device 108 of the computing device 102 using touchscreen functionality. Module 105 can be utilized to recognize single-finger gestures and bezel gestures, multiple-finger/same-hand gestures and bezel gestures, and/or multiple-finger/different-hand gestures and bezel gestures.

The computing device 102 may also be configured to detect and differentiate between a touch input (e.g., provided by one or more fingers of the user's hand) and a stylus input (e.g., provided by a stylus 116). The differentiation may be performed in a variety of ways, such as by detecting an amount of the display device 108 that is contacted by the finger of the user's hand versus an amount of the display device 108 that is contacted by the stylus 116.

Thus, the gesture module 105 may support a variety of different gesture techniques through recognition and leverage of a division between stylus and touch inputs, as well as different types of touch inputs.

FIG. 2 illustrates an example system 200 showing the web browser 103, riff module 104, and gesture module 105 as being implemented in an environment where multiple devices are interconnected through a central computing device. The central computing device may be local to the multiple devices or may be located remotely from the multiple devices. In one embodiment, the central computing device is a “cloud” server farm, which comprises one or more server computers that are connected to the multiple devices through a network or the Internet or other means.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to the generic class of devices. A class of device may be defined by physical features or usage or other common characteristics of the devices. For example, as previously described the computing device 102 may be configured in a variety of different ways, such as for mobile 202, computer 204, and television 206 uses. Each of these configurations has a generally corresponding screen size and thus the computing device 102 may be configured as one of these device classes in this example system 200.

For instance, the computing device 102 may assume the mobile 202 class of device which includes mobile telephones, music players, game devices, and so on. The computing device 102 may also assume a computer 204 class of device that includes personal computers, laptop computers, netbooks, and so on. The television 206 configuration includes configurations of device that involve display in a casual environment, e.g., televisions, set-top boxes, game consoles, and so on. Thus, the techniques described herein may be supported by these various configurations of the computing device 102 and are not limited to the specific examples described in the following sections.

Cloud 208 is illustrated as including a platform 210 for web services 212. The platform 210 abstracts underlying functionality of hardware (e.g., servers) and software resources of the cloud 208 and thus may act as a “cloud operating system.” For example, the platform 210 may abstract resources to connect the computing device 102 with other computing devices. The platform 210 may also serve to abstract scaling of resources to provide a corresponding level of scale to encountered demand for the web services 212 that are implemented via the platform 210. A variety of other examples are also contemplated, such as load balancing of servers in a server farm, protection against malicious parties (e.g., spam, viruses, and other malware), and so on. In at least some embodiments, web services 212 can be utilized to provide a riff management module 107 that operates as described above and below.

For example, the riff management module 107, in concert with the riff module 104, can provide an ability for users to locate relevant multimedia building blocks for use in adding to posts in a manner which robustly adds to a particular conversation. In one or more embodiments, a thread of conversation can be created across many posts and times. Conversation threads created by riff module 104 can be managed and curated by riff management module 107. For example, the riff management module 107 can define associations and links between posts through indexing techniques, e.g., distributed inverted indexing, that allows for fast queries across an entire set of related riff posts during and after creation of threaded multimedia conversations. Further, in at least some embodiments, the riff management module 107 can enable riff module 104 to leverage an integrated search engine during construction of a threaded conversation.

Thus, the cloud 208 is included as a part of the strategy that pertains to software and hardware resources that are made available to the computing device 102 via the Internet or other networks. For example, the riff functionality may be implemented in part on the computing device 102, as well as via platform 210 that supports web services 212, as described above and below.

The gesture techniques supported by the gesture module may be detected using touchscreen functionality in the mobile configuration 202, track pad functionality of the computer 204 configuration, detected by a camera as part of support of a natural user interface (NUI) that does not involve contact with a specific input device, and so on. Further, performance of the operations to detect and recognize the inputs to identify a particular gesture may be distributed throughout the system 200, such as by the computing device 102 and/or the web services 212 supported by the platform 210 of the cloud 208.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory devices. The features of the gesture techniques described below are platform-independent, meaning that the techniques may be implemented on a variety of commercial computing platforms having a variety of processors.

In the discussion that follows, various sections describe various example embodiments. A section entitled “Example Embodiment” describes functionality associated with creating threaded multimedia conversations in accordance with one or more embodiments. Next, a section entitled “Example Social Networking System” describes an example social networking system in which various embodiments can be employed. Following this, a section entitled “Example Method” describes an example method in accordance with one or more embodiments. Last, a section entitled “Example Device” describes aspects of an example device that can be utilized to implement one or more embodiments.

Having described example operating environments in which the riffing functionality can be utilized, consider now a discussion of various embodiments.

### Example Embodiment

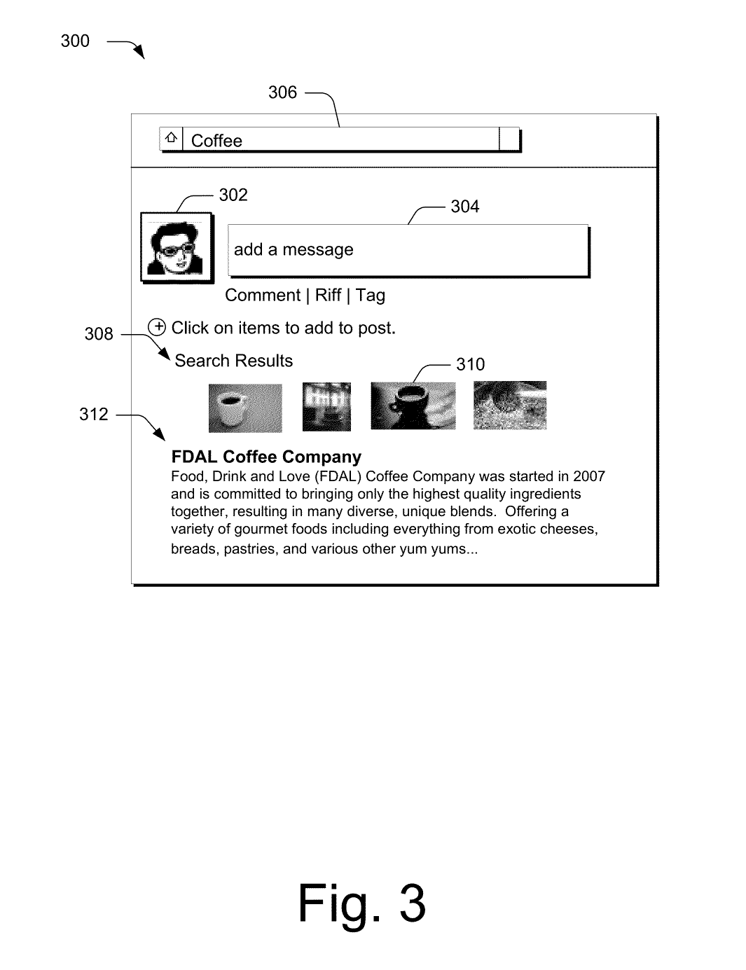

As noted above, various embodiments provide an ability for users to locate relevant multimedia building blocks for use in building posts or adding to posts in a manner which robustly adds to a particular conversation. Posts can be “riffed” by other users to add to the post and incorporate interesting multimedia content. On the client-side devices, riff functionality is provided by a module, such as riff module 104 in FIGS. 1 and 2. The riff module includes a user interface component that provides a rich interface that a user can utilize to build a post. As but one example of a user interface, consider FIG. 3.

There, an example user interface, in accordance with one or more embodiments, is shown generally at 300. In this particular example, the user interface enables display of an icon or image 302 associated with a user who intends to build a post that can be riffed by other users. A text box 304 is provided to enable the user to enter a message or comment associated with their post. In addition, in at least some embodiments, the user interface 300 includes an integrated search component 306 that enables the user to conduct searches to discover multimedia content that can be added to their post. The integrated search component can work in concert with a suitably-configured search engine to return search results to a user. In this particular example, the user has entered the search term “coffee” into the search component 306. A corresponding search engine utilizes the entered search term to conduct a search and return relevant results that are displayed in a “Search Results” section 308. Any suitable type of content can be presented in the search results section 308. In the present example, the search results section can include various images, an example of which is shown at 310. Alternately or additionally, the search results section 308 can include links, such as 312, to content corresponding to the search. Further, the search results section 308 can include audiovisual content, such as videos and the like that can be added to the user's post.

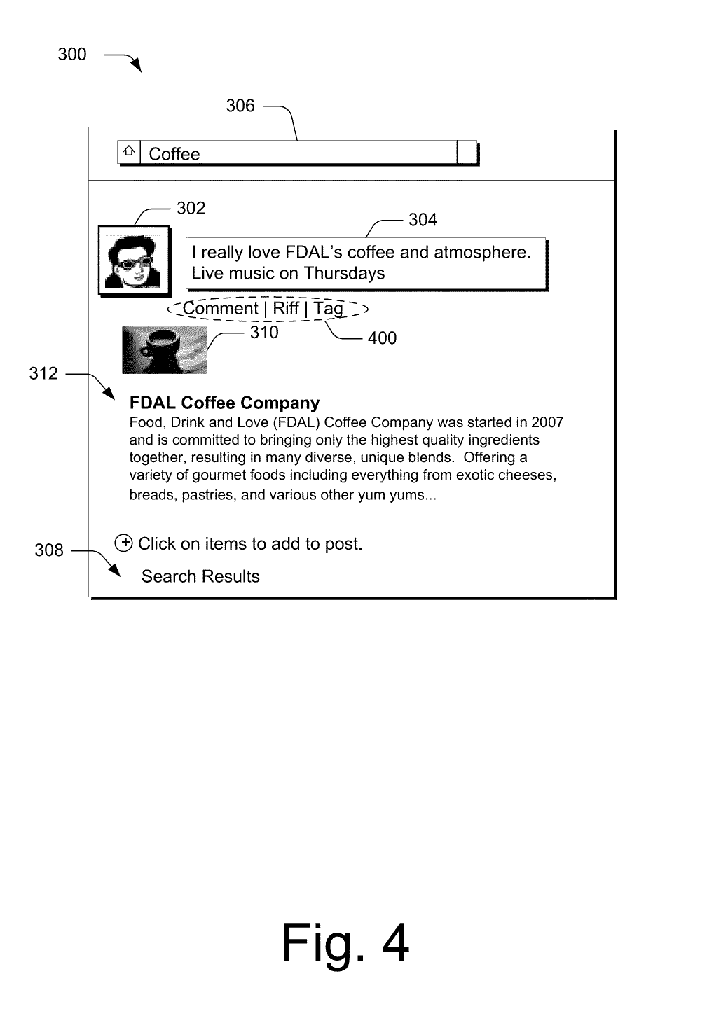

Once the user has conducted their search, an option can be selected so that the user can click on items to add to their post. Before or after selected items are added to the user's post, the user can enter a message in text box 304. As an example, consider FIG. 4.

There, user interface 300 is shown after the user has selected content for their post. Specifically, in this example, the user has selected image 310 and link 312 to be incorporated into their post. Notice that as the user builds their post, the search results section 308 is moved to a position that is visually below content that the user has selected to add to their post. The user can continue to add to their post by scrolling down to select various content that appears in the search results section 308.

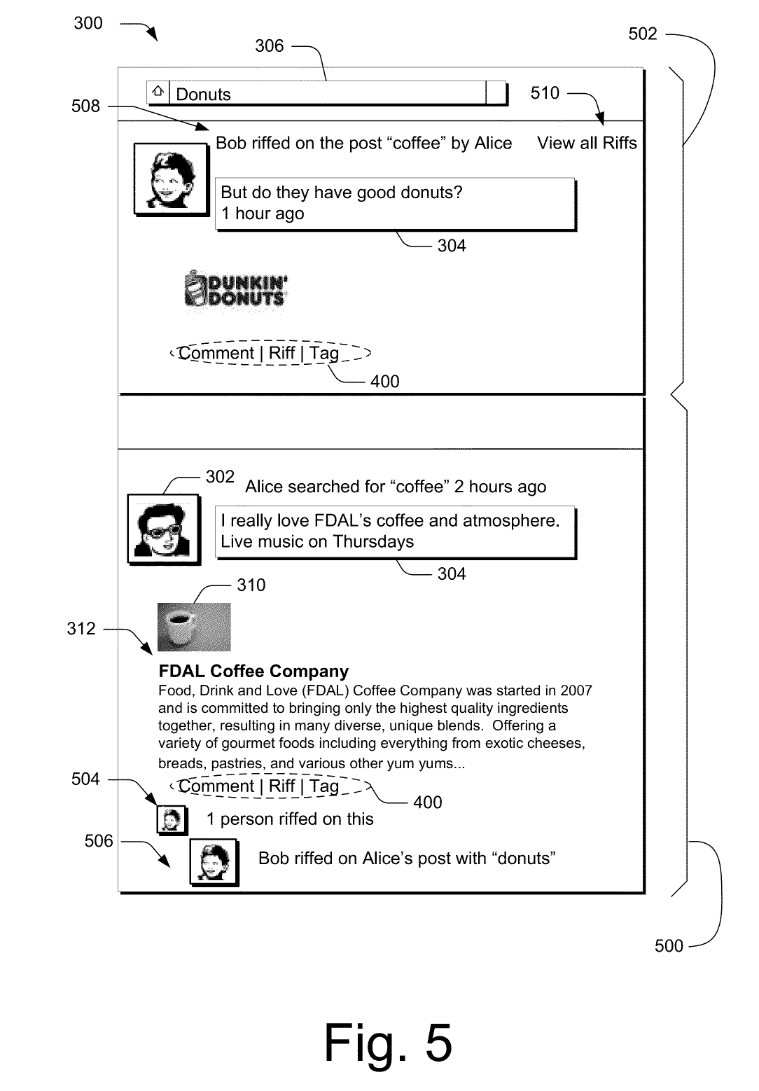

Notice that the user interface 300 includes a section 400 that enables other users to “comment”, “riff”, and/or “tag” a particular post. In the illustrated and described embodiment, clicking on “riff” begins a new post which constitutes a response to the original post. This response then starts a conversation that can be richly added to by other users. As an example, consider FIG. 5.

There, user interface 300 includes a first portion 500 that corresponds to the original post and a second portion 502 that corresponds to a new post or riff of the original post. In the illustrated and described embodiment, the user interface includes a portion 504 that indicates how many users have riffed on the original post and an annotation 506 with a note linking to the new post so that other users can discover the new riff. For example, by clicking on the link in the note, a new user can be navigated to a particular riff and, in addition, see other posts that have been produced using a riff on that particular post. This is particularly helpful with posts that have a large number of riffs associated with them.

With respect to the new post or riff that appears in second portion 502, an annotation 508 attributes the new post to the original post and provides a link that can be used to navigate to the original post. Each of the posts that appear, respectively, in portions 500, 502 includes a section 400 that enables other users to comment, riff, or tag the particular post.

Further, in one or more embodiments, user interface 300 includes a selectable element 510 that enables users to view all of the riffs associated with a particular post. Thus, by clicking on selectable element 510, a user can access and view all of the riffs associated with the original post. In addition, the new post can have multimedia content added to it using the same integrated search component 306. In this example, Bob has riffed on the post “coffee” by Alice. Bob entered the search term “donuts” in search component 306 and, correspondingly, was presented with multimedia search results similar to that shown in FIG. 3. Bob selected a “Dunkin' Donuts” image and added a comment in his text box 304 asking “But do they have good donuts?”.

Using the above-described approach, a social networking experience can be provided in which a thread of conversation can be created across many posts. For example, in the example described just above users can riff not only on the original post that appears in portion 500, but also on Bob's post that appears in portion 502. So, for example, if users continue to riff on the original post, the conversation may remain generally related to coffee shops and their various offerings. However, users who choose to riff on Bob's post may drive the conversation in a divergent direction such as one that would discuss donuts, pastries, bakeries, cakes, and the like. In this manner each individual post may serve as a springboard into different multimedia threaded conversations.

In addition, the above-described approach can enable lineages of multimedia conversations to be tracked and visualized across a series of posts, allowing for a nonlinear tree of connections among related posts. Further, using the integrated search component 306 enables access to a rich collection of multimedia content that can be used to build derivative riff posts.

Having discussed an example embodiment, consider now a discussion of a social networking system that can be utilized to enable searching and selection of rich multimedia content for derivative riff posts.

Example Social Networking System

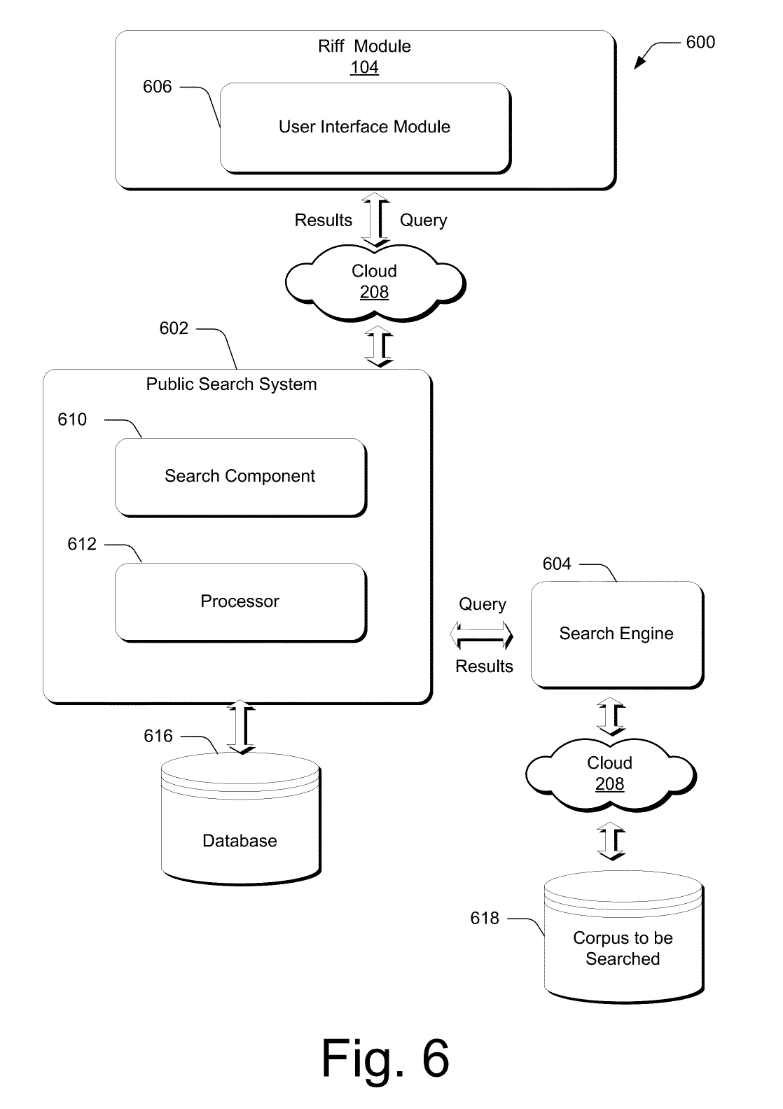

FIG. 6 describes general aspects of a social networking system, shown generally at 600, including an infrastructure that supports social networking functionality, as well as creation of posts and derivative riff posts through a suitable user interface, such as the one described just above. It is to be appreciated and understood that the system described below constitutes but one system that can be used to implement the embodiments described herein. As such, other systems can be used without departing from the spirit and scope of the claimed subject matter.

Social networking system 600 includes riff module 104, a public search system 602 and a search engine 604, in accordance with one or more embodiments.

Riff module 104 includes a user interface module 606 that is configured to present a user interface such as the one described above. Public search system 602 includes, among other components, a search component 610 and a processor 612. Social networking system 600 also includes a database 616 that maintains information associated with posts and derivative riff posts, and a database 618 that represents one or more corpus to be search by search engine 604.

Riff module 104 enables communication with public search system 602 via a suitably configured network, such as cloud 208.

In operation, the user interface module 606 enables a user to set up a social networking account which includes, for example, a user name and password. The user can input these items through the interface module, and the items are stored in database 616. In one or more embodiments, the user can create posts that can be riffed as described above. These posts can be stored in database 616. The database 616 can then be used to manage and curate posts and derivative posts that are created through riffing. Specifically, database 616 can be utilized to organize various posts and index them using, for example, a cloud distributed inverted index that allows for fast queries across an entire set of related riff posts. The riff posts can be linked, in the manner described above, such that associations between the posts can be easily navigated, explored, and built upon.

Once the user sets up a social networking account, the user can log on to the system through, for example, an authentication component. The user interface module 606 can then generate a user interface display, such as the ones described above.

As an example, consider the following. Assume that a user wishes to create an initial post that can be added to, by other users, through the riffing functionality described above. In this example, riff module 104 can be utilized, through its user interface module 606, to present a suitably-configured user interface through which the user can create their initial or original post. An example user interface is shown in FIG. 3. There, user interface 300 includes a search component 306 which can be used, by the user, to enter one or more search terms. These search terms can be provided by the search component 306 to the public search system 602 (FIG. 6) and search component 610. The search component 610 can then send the search terms to the search engine 604 and the search engine 604 can use the search terms to execute the search against database 618. Search results can then be returned to search component 610 in the public search system 602 and then, in turn, returned to the user interface module 606 for display in search results section 308 (FIG. 3) of the user interface.

The user can now select from among the search results to add to their original post and, in addition, can add comments in text box 304 as described above and shown in FIG. 4. Once the original post is established, other users are free to add to the post in the manner described above. For example, a new user can click on “riff” appearing in section 400 to begin a new post which constitutes a response to the original post. By doing so, riff module 104 executing on the new user's client device can present a suitably-configured user interface, such as the one shown in FIG. 5, which allows the new user to add multimedia content to the original post through the use of an integrated search component 306. An example of how this can be done is provided above.

Having considered an example social networking system that enables a user to create original posts and have those posts riffed by other users, consider now an example method in accordance with one or more embodiments.

Example Methods

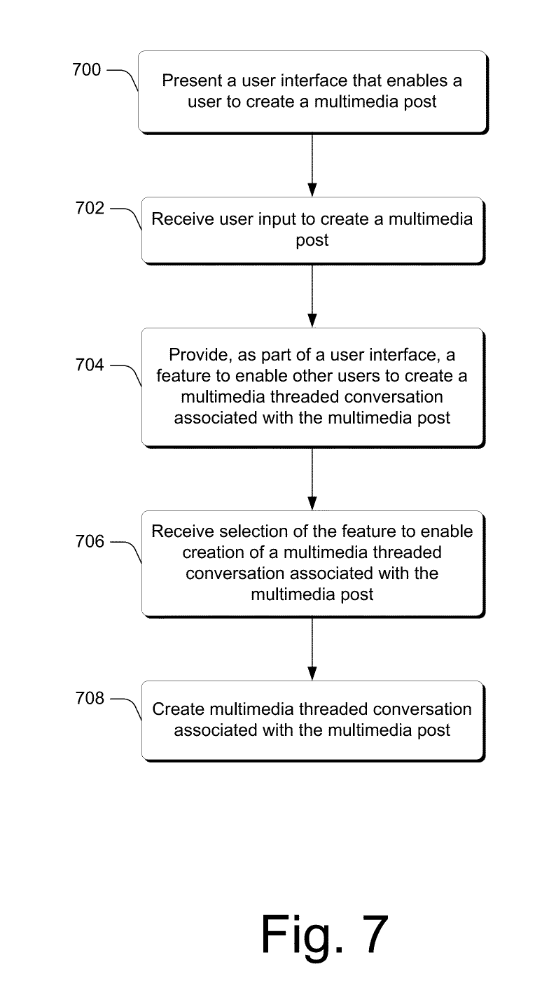

FIG. 7 is a flow diagram that describes steps in a method in accordance with one or more embodiments. The method can be performed in connection with any suitable hardware, software, firmware, or combination thereof. In at least some embodiments, the method can be performed by software in the form of a riff module, such as module 104 in FIG. 1, which may or may not work in concert with a suitably-configured web browser. Aspects can also be performed by riff manager module 107 (FIG. 2).

Step 700 presents a user interface that enables a user to create a multimedia post. This step can be accomplished in any suitable way. For example, in at least some embodiments, the user interface includes an integrated search component that can be used to return multimedia search results that can be selected and incorporated into a multimedia post. Step 702 receives user input to create a multimedia post. This step can be performed in any suitable way. For example, in at least some embodiments, the user input can include selection of multimedia content such as, by way of example and not limitation, images, links, videos, text, and other related content. In at least some embodiments, the user input can select multimedia content from one or more remote sources and/or one or more local sources for incorporation in the post.

Step 704 provides, as part of a user interface, a feature to enable other users to create a multimedia threaded conversation associated with the multimedia post. In the example described above, this feature resides in the form of a “riff” selection. In the embodiments described above, this feature is not a “comment” feature, a “tag” feature, or a “like” feature. Rather, in at least some embodiments, the feature is one that is specifically dedicated to enabling the creation of derivative, threaded, multi-media posts.

Step 706 receives selection of the feature effective to enable creation of a multimedia threaded conversation associated with the multimedia post. In the illustrated and described embodiment, this can cause presentation of a user interface that includes or otherwise makes us of a search component, such as integrated search component 306, to enable a new user to riff on the original multimedia post. Step 708 creates a multimedia threaded conversation associated with the multimedia post. This step can be performed by including search results spawned from search terms that are entered by the new user into the integrated search component. Subsequently, the new user can select individual search results including, by way of example and not limitation, images, links, video, text, and other content to build their response to the original multimedia post. Examples of how this can be done are provided above. The other users can now add to the original post by riffing, as described above. In addition, other users can create derivative posts by riffing on subsequent posts to the original post. In this manner, the conversation associated with the original post can be expanded upon and, in addition, subsequent posts can be the subject of derivative conversations that diverge from the context of the original post.

Having described various embodiments, consider now a discussion of an example device that can be utilized to implement the embodiments described above.

Example Device

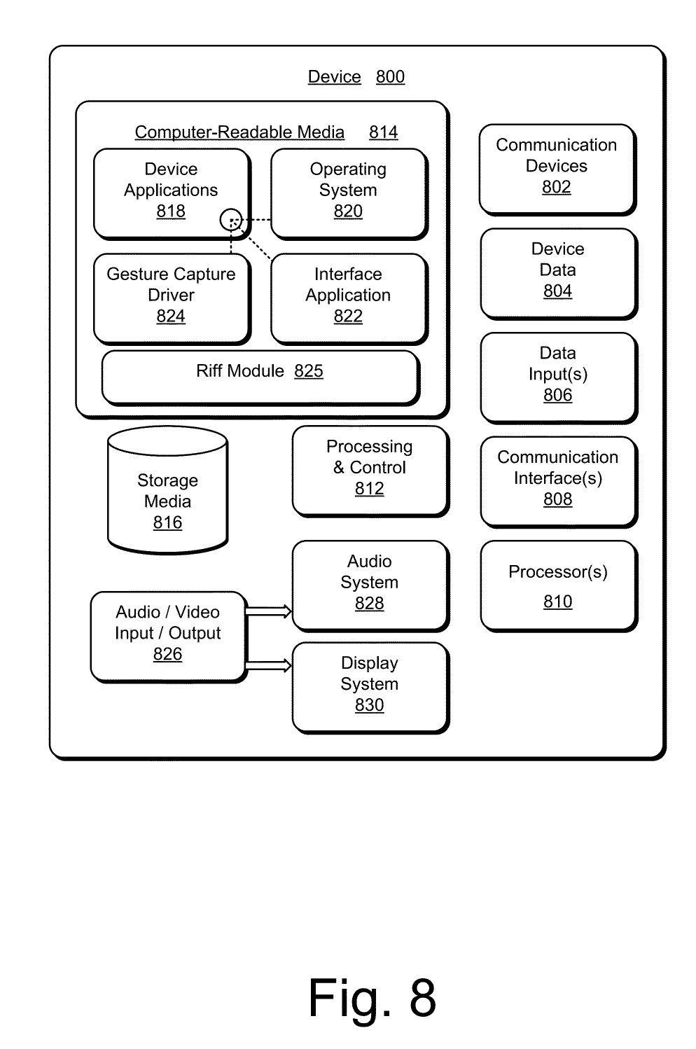

FIG. 8 illustrates various components of an example device 800 that can be implemented as any type of portable and/or computer device as described with reference to FIGS. 1 and 2 to implement embodiments of the riff functionality described herein. Device 800 includes communication devices 802 that enable wired and/or wireless communication of device data 804 (e.g., received data, data that is being received, data scheduled for broadcast, data packets of the data, etc.). The device data 804 or other device content can include configuration settings of the device, media content stored on the device, and/or information associated with a user of the device. Media content stored on device 800 can include any type of audio, video, and/or image data. Device 800 includes one or more data inputs 806 via which any type of data, media content, and/or inputs can be received, such as user-selectable inputs, messages, music, television media content, recorded video content, and any other type of audio, video, and/or image data received from any content and/or data source.

Device 800 also includes communication interfaces 808 that can be implemented as any one or more of a serial and/or parallel interface, a wireless interface, any type of network interface, a modem, and as any other type of communication interface. The communication interfaces 808 provide a connection and/or communication links between device 800 and a communication network by which other electronic, computing, and communication devices communicate data with device 800.

Device 800 includes one or more processors 810 (e.g., any of microprocessors, controllers, and the like) which process various computer-executable or readable instructions to control the operation of device 800 and to implement the embodiments described above. Alternatively or in addition, device 800 can be implemented with any one or combination of hardware, firmware, or fixed logic circuitry that is implemented in connection with processing and control circuits which are generally identified at 812. Although not shown, device 800 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 800 also includes computer-readable media 814, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 800 can also include a mass storage media device 816.

Computer-readable media 814 provides data storage mechanisms to store the device data 804, as well as various device applications 818 and any other types of information and/or data related to operational aspects of device 800. For example, an operating system 820 can be maintained as a computer application with the computer-readable media 814 and executed on processors 810. The device applications 818 can include a device manager (e.g., a control application, software application, signal processing and control module, code that is native to a particular device, a hardware abstraction layer for a particular device, etc.), as well as other applications that can include, web browsers, image processing applications, communication applications such as instant messaging applications, word processing applications and a variety of other different applications. The device applications 818 also include any system components or modules to implement embodiments of the techniques described herein. In this example, the device applications 818 include an interface application 822 and a gesture-capture driver 824 that are shown as software modules and/or computer applications. The gesture-capture driver 824 is representative of software that is used to provide an interface with a device configured to capture a gesture, such as a touchscreen, track pad, camera, and so on. Alternatively or in addition, the interface application 822 and the gesture-capture driver 824 can be implemented as hardware, software, firmware, or any combination thereof. In addition, computer readable media 814 can include a riff module 825 that functions as described above.

Device 800 also includes an audio and/or video input-output system 826 that provides audio data to an audio system 828 and/or provides video data to a display system 830. The audio system 828 and/or the display system 830 can include any devices that process, display, and/or otherwise render audio, video, and image data. Video signals and audio signals can be communicated from device 800 to an audio device and/or to a display device via an RF (radio frequency) link, S-video link, composite video link, component video link, DVI (digital video interface), analog audio connection, or other similar communication link. In an embodiment, the audio system 828 and/or the display system 830 are implemented as external components to device 800. Alternatively, the audio system 828 and/or the display system 830 are implemented as integrated components of example device 800.

### CONCLUSION

Various embodiments provide an ability for users to locate relevant multimedia building blocks for use in adding to posts in a manner which robustly adds to a particular conversation.

In one or more embodiments, a thread of conversation can be created across many posts and times. Embodiments can extend the notion of textual of replies by allowing a multimedia conversation across a series of posts. Multimedia conversation lineages can be tracked and visualized across a series of posts, thus allowing for a non-linear tree of connections among related posts. Various embodiments can allow for a community-driven collaborative effort such as, for example, collaborative stories, were associations, and the like, instead of fixed-structure, purpose-built interactions.

In addition, at least some embodiments can utilize an integrated social search engine to provide for a shared context for constructing derivative posts.

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

1. One or more computer readable storage memories comprising computer readable instructions which, when executed, provide a user interface comprising:
a text box configured to enable a user to enter a message or comment associated with a multimedia post;
a search component configured to enable the user to conduct searches to discover multimedia content that can be added to the multimedia post;
a search results section configured to present multimedia search results returned from a search using the search component; and
an option configured to permit selection of one or more multimedia search results to be added to the multimedia post; and
a riff selection specifically dedicated to enabling creation of derivative, threaded, multimedia posts.

2. The one or more computer readable storage memories of claim 1, wherein the multimedia search results comprise one or more of images, links, or video.

3. The one or more computer readable storage memories of claim 1, wherein the user interface further comprises a section that enables other users to begin a new post which constitutes a multimedia response to the multimedia post.

4. The one or more computer readable storage memories of claim 1, wherein the user interface is configured to include a first portion that corresponds to the multimedia post and at least one second portion that corresponds to a new multimedia post associated with the multimedia post that appears in the first portion.

5. The one or more computer readable storage memories of claim 1, wherein the user interface is configured to include a first portion that corresponds to the multimedia post and at least one second portion that corresponds to a new multimedia post associated with the multimedia post that appears in the first portion, the at least one second portion being configured to include a portion that indicates how many users have created new multimedia posts associated with the multimedia post that appears in the first portion.

6. The one or more computer readable storage memories of claim 1, wherein the user interface is configured to include a first portion that corresponds to the multimedia post and at least one second portion that corresponds to a new multimedia post associated with the multimedia post that appears in the first portion, the first portion being configured to include an annotation with a note linking to the new multimedia post.

7. The one or more computer readable storage memories of claim 1, wherein the user interface is configured to include a first portion that corresponds to the multimedia post and at least one second portion that corresponds to a new multimedia post associated with the multimedia post that appears in the first portion, the first portion being configured to include an annotation with a note linking to the new multimedia post, the note linking to the new multimedia post being configured to enable navigation to the new multimedia post.

8. The one or more computer readable storage memories of claim 1, wherein the user interface is configured to include a first portion that corresponds to the multimedia post and at least one second portion that corresponds to a new multimedia post associated with the multimedia post that appears in the first portion, the at least one second portion being configured to include an annotation that attributes the new multimedia post to the multimedia post that appears in the first portion.

9. The one or more computer readable storage memories of claim 1, wherein the user interface is configured to include a first portion that corresponds to the multimedia post and at least one second portion that corresponds to a new multimedia post associated with the multimedia post that appears in the first portion, the at least one second portion being configured to include an annotation that attributes the new multimedia post to the multimedia post that appears in the first portion, the annotation being configured to provide a link that can be used to navigate to the multimedia post that appears in the first portion.

10. The one or more computer readable storage memories of claim 1, wherein the user interface is configured to include a first portion that corresponds to the multimedia post and at least one second portion that corresponds to a new multimedia post associated with the multimedia post that appears in the first portion, wherein each of the first and at least one second portions include respective sections that enable other users to begin new posts which constitute respective multimedia responses to posts that appear in the first and at least one second portions.

11. The one or more computer readable storage memories of claim 1, wherein the user interface is configured to include a first portion that corresponds to the multimedia post and at least one second portion that corresponds to a new multimedia post associated with the multimedia post that appears in the first portion, wherein the user interface includes a selectable element that is configured to enable viewing of all multimedia posts associated with the multimedia post appearing in the first portion.

12. A computer-implemented method comprising:
presenting a user interface that enables a user to create a multimedia post, the user interface being configured to enable the user to enter a message or comment associated with the multimedia post and to use a search component configured to enable the user to conduct searches to discover multimedia content that can be added to the multimedia post; and
receiving user input to create the multimedia post by at least receiving selection of one or more of an image, link, or video to include in the multimedia post, the user interface including a riff selection specifically dedicated to enabling creation of derivative, threaded, multimedia posts.

13. The computer-implemented method of claim 12, wherein the search component is integrated with the user interface.

14. The computer-implemented method of claim 12, wherein the user interface further comprises a section that enables other users to begin a new post which constitutes a multimedia response to the multimedia post.

15. The computer-implemented method of claim 12, wherein the user interface is configured to include a first portion that corresponds to the multimedia post and at least one second portion that corresponds to a new multimedia post associated with the multimedia post that appears in the first portion.

16. The computer-implemented method of claim 12, wherein the user interface is configured to include a first portion that corresponds to the multimedia post and at least one second portion that corresponds to a new multimedia post associated with the multimedia post that appears in the first portion, the first portion being configured to include an annotation with a note linking to the new multimedia post, the note linking to the new multimedia post being configured to enable navigation to the new multimedia post; and
the at least one second portion being configured to include an annotation that attributes the new multimedia post to the multimedia post that appears in the first portion, the annotation being configured to provide a link that can be used to navigate to the multimedia post that appears in the first portion.

17. A system comprising:
one or more processors;
a public search system comprising a search component embodied in instructions embodying a computer-readable storage medium, the instructions executed by the one or more processors, the search component being configured to:
receive, from a client device, search terms associated with building a multimedia post;
receive, from a search engine, search results associated with the search terms; and
return the search results to the client device; and
a database configured to manage threaded, multimedia posts, wherein at least one of the threaded, multimedia posts includes a first portion that corresponds to an original multimedia post and at least one second portion that corresponds to a new multimedia post associated with the original post, each of the first and at least one second portions including respective sections that contain a riff selection to enable other users to begin new posts which constitute respective multimedia responses to posts that appear in the first and at least one second portions, the multimedia responses including one or more of images, links or video, the riff selection being specifically dedicated to enabling creation of derivative, threaded, multimedia posts.

18. The system of claim 17, wherein the at least one second portion is configured to include a portion that indicates how many users have created new multimedia posts associated with the original post, and the first portion is configured to include an annotation with a note linking to the new multimedia post, the note linking to the new multimedia post being configured to enable navigation to the new multimedia post.

19. The system of claim 17, wherein the at least one second portion is configured to include an annotation that attributes the new multimedia post to the original post that appears in the first portion.

20. The system of claim 17, wherein the at least one second portion is configured to include an annotation that attributes the new multimedia post to the original post that appears in the first portion, wherein the annotation is configured to provide a link that can be used to navigate to the original post that appears in the first portion.
